(19) United States
(12) Patent Application Publication
(10) Pub. No.: US 2014/0273169 A1
(43) Pub. Date: Sep. 18, 2014

(54) POLYMER COMPOSITIONS COMPRISING ALGAE MATERIALS

(71) Applicant: Cereplast, Inc., El Segundo, CA (US)

(72) Inventors: Frederic Scheer, Hawthorne, CA (US); Kelvin T. Okamoto, Carmel, IN (US); William E. Kelly, Hawthorne, CA (US)

(73) Assignee: Cereplast, Inc., El Segundo, CA (US)

(21) Appl. No.: 13/831,095

(22) Filed: Mar. 14, 2013

(51) Int. Cl. C08L 23/12

(52) U.S. Cl. CPC C08L 23/12
USPC 435/257.1; 524/9; 523/122

(57) ABSTRACT

Polymer compositions and methods of making and using the polymer compositions are provided. In a general embodiment, the present disclosure provides a composition comprising a polymer, a compatibilizer and an algae product.

### BACKGROUND

The present disclosure is directed to polymer compositions. More specifically, the present disclosure is directed to improved polymer compositions, articles produced from the polymer compositions and processes relating to the polymer compositions.

Consumer products made from plastics come in a variety of forms. Such products include, for example, toys, computer casing, DVDs, toiletries, cellular phone casings, and automobile parts are greatly used nowadays. Unfortunately, the widespread and even growing use of such plastic materials for making these consumer products results in increasing dependence on fossil fuels each day. For example, the plastic materials that make up many of these consumer products require large amounts of oil for their production.

### SUMMARY

The present disclosure generally relates to polymer compositions and methods of making and using the polymer compositions. For example, the polymer compositions can be made using algae products and can be more environmentally friendly. In a general embodiment, the present disclosure provides a composition comprising a polymeric material, a compatibilizer and an algae product.

In an embodiment, the polymer is selected from the group comprised of polyolefins, polyamides, polyesters and polyacrylates.

In an embodiment, the polyolefin is selected from the group consisting of polyethylene, polypropylene, polybutene and other combinations of olefinic monomers selected from the group consisting of ethylene, propylene, butene, butadiene, pentene, hexene, octane, styrene, acrylates and methacrylates.

In an embodiment, the polyester is selected from the group consisting of polylactic acid, polybutylene succinate, polybutylene adipate-co-terephthalate, polyethylene terephthalate, polyhydroxy alkanoate and combinations thereof.

In an embodiment, the polyamide is selected from the group consisting of polyamide 6, polyamide 10, polyamide 4,10, polyamide 66, polyamide 12 and combinations thereof.

In an embodiment, the compatibilizer is selected from the group consisting of grafted or functionalized polymers including maleic anhydride grafted polypropylene, glycidyl grafted polypropylene, maleic anhydride grafted polyethylene, maleic anhydride grafted polybutene and combinations thereof.

In an embodiment, the compatibilizer comprises maleated polypropylene with a melt flow of about 50 to about 500 g/10 minute and maleic anhydride grafting of about 0.5 to about 10 wt %.

In an embodiment, the algae product is selected from the group algae itself or algae biomass.

In an embodiment, the algae biomass is the result of extraction or removal of biofuel, nutrients, pharmaceuticals and other specialty chemicals.

In an embodiment, the algae product has less than or equal to 5% moisture by weight and, in some embodiments, less than or equal to 4% moisture by weight.

In an embodiment, the algae product has an average particle size less than or equal to 50 microns and, in some embodiments, less than or equal to 20 microns.

In an embodiment, the algae product has substantially no odor.

In an embodiment, the algae product is bleached by chemicals or light prior to use.

In an embodiment, the composition is bleached by chemicals or light.

In an embodiment, the polymeric material comprises from about 10% to about 94% by weight, the compatibilizer comprises from about 1 to about 10% by weight and the algae product comprises from about 5% to about 90%.

In an embodiment, the polymeric material comprises from about 35% to about 92% by weight, the compatibilizer comprises from about 3 to about 7% by weight and the algae product comprises from about 10% to about 60%.

In an embodiment, the composition further comprising at least one component selected from the group consisting of plasticizers, starches, stabilizers, colorants, antioxidants, flavorants, nanofillers, non-clay particles, glass-fiber reinforcements, anti-microbial agents, processing aids and combinations thereof.

In an embodiment, the starch is selected from the group consisting of corn, tapioca, maize, wheat, rice, potato, sweet potato and pea and combinations thereof.

In an embodiment, the starch content is about 10% to 40% by weight.

In an embodiment, the starch is chemically unmodified.

In an embodiment, the plasticizer is selected from the group consisting of polyethylene glycol, sorbitol, glycerine and combinations thereof.

In an embodiment, the anti-microbial agents are selected from the group consisting of zinc oxide, copper and copper compounds, silver and silver compounds, colloidal silver, silver nitrate, silver sulfate, silver chloride, silver complexes, metal-containing zeolites, surface-modified metal-containing zeolites and combinations thereof.

In an embodiment, the metal-containing zeolites comprise a metal selected from the group consisting of silver, copper, zinc, mercury, tin, lead, bismuth, cadmium, chromium, cobalt, nickel, zirconium and combinations thereof.

In an embodiment, the anti-microbial agents are selected from the group consisting of o-benzyl-phenol, 2-benzyl-4-chloro-phenol, 2,4,4′-trichloro-2′-hydroxydiphenyl ether, 4,4′-dichloro-2-hydroxydiphenyl ether, 5-chloro-2-hydroxy-diphenyl-methane, mono-chloro-o-benzyl-phenol, 2,2′-methylenbis-(4-chloro-phenol), 2,4,6-trichlorophenol and combinations thereof.

In another embodiment, the present disclosure provides a method of making a polymer composition. The method comprises blending a polymer and algae product to form a finished plastic pellet using extrusion.

In an embodiment, the method can further comprise of melting and shaping the pellets to form an article selected from the group consisting of toys, computer casings, DVDs, toiletries, combs, consumer products, cellular phone casings, bags, foam material products, packaging, automobile parts, cookware and combinations thereof.

In an embodiment, the method can further comprise of articles being made by a process selected from the group consisting of injection molding, thermoforming, blown film extrusion, stretch blow molding, extrusion blow molding, extrusion coating, profile extrusion, cast film extrusion, sheet extrusion, thermoforming, and cast molding and combinations thereof.

In yet another embodiment, an article is produced using a composition comprising a polymer, a compatibilizer and an algae product.

In an embodiment, the article is from the group consisting of toys, computer casings, DVDs, toiletries, combs, consumer products, cellular phone casings, bags, foam material products, packaging, automobile parts, cookware and combinations thereof.

In an embodiment, the article is made by a process selected from the group consisting of injection molding, thermoforming, blown film extrusion, stretch blow molding, extrusion blow molding, extrusion coating, profile extrusion, cast film extrusion, sheet extrusion, thermoforming, and cast molding and combinations thereof.

An advantage of the present disclosure is to provide improved polymer compositions.

Another advantage of the present disclosure is to provide improved methods of making polymer compositions.

Yet another advantage of the present disclosure is to provide polymer compositions containing algae product.

Still another advantage of the present disclosure is to provide improved articles comprising polymer compositions containing algae products.

Additional features and advantages are described herein, and will be apparent from, the following Detailed Description.

### DETAILED DESCRIPTION

The present disclosure relates to polymer compositions and methods of making and using the polymer compositions. The polymer compositions can be made using bio-based content, which can reduce the need for fossil fuels. In a general embodiment, the present disclosure provides a composition comprising a polymeric material, a compatibilizer and an algae product.

There is a need to reduce our dependence on fossil fuels. The plastics industry is using about 2 to 4% of all the oil processed in the United States every year. This is a significant amount given that fossil fuels are not a renewable source and cannot be replenished quickly. As importantly, the use of fossil fuels tends to increase the carbon footprint of materials and thus leads to increased global warming potential. Incorporation of algae product into petroleum-based and even bio-based polymers in accordance with embodiments of the present disclosure can help to reduce the dependence on oil and reduce global warming.

The polymeric materials (also referred to as polymers) described herein may be a thermoplastic that is produced from any combination of monomers or low molecular weight precursors that can produce a polymer. Monomers can include alkenes—such as ethylene, propylene, butadiene, hexene, octane, cumene and styrene—, acrylates and methacrylates, polyfunctional chemicals—such as diacid, diamines, diesters, aminoacids, diols and hydroxyacids. The polymers can be produced by any chemical means known such as a condensation reaction or a radical polymerization with and without catalysts in both instances. The thermoplastic polymer or combination of thermoplastic polymers may be among amorphous, semicrystalline or crystalline polymers.

Examples of typical polymeric materials include polyethylene—including low density polyethylene, linear low density polyethylene and high density polyethylene—, polypropylene—including homopolymers, random copolymers and impact copolymers—, polyamides—including polyamide 6, polyamide 10, polyamide 4, 10, polyamide 66 and polyamide 12—, polyesters—including lactic acid, polyethylene terephthalate, polybutylene succinate and polybutylene adipate-co-terephthalate—, polystyrene, polyacrylate, polycarbonate and thermoplastic elastomers, or mixtures and/or blends of any of the foregoing.

The polymeric materials may also be virgin, scrap, post-industrial recycled or post-consumer material.

As used herein, the term “compatibilizer” means a material that can provide blending between a polymer and algae product. It has been surprisingly found that by using a compatibilizer that enhances the interfacial adhesion between hydrophobic polymers and algae product, an improved polymer composition was produced. For example, the compatibilizer can be maleic anhydride grafted polypropylene, glycidyl grafted polypropylene, maleic anhydride grafted polyethylene, maleic anhydride grafted polybutene or combinations thereof. For example, the compatibilizer can comprise maleated polypropylene with a melt flow of about 50 to about 500 g/10 minute and maleic anhydride grafting of about 0.5 to about 10 wt %.

Some non-limitative examples of suitable compatibilizers include Epolene® E-43 (maleated polypropylene), Epolene G-3003 (maleated polypropylene), Epolene G-3015 (maleated polypropylene), Epolene C-16 (maleated polyethylene), and Epolene C-18 (maleated polyethylene). The Epolene series of polymer waxes and polymers is commercially available from Eastman Chemical Company, in Kingsport, Term. Epolene polymers are medium to low molecular weight polyethylene or polypropylene. They are useful in the plastics industry as lubricants for PVC, processing aids, mold release agents, dispersion aids, and coupling agents. They are also widely used as base polymers for hot-melt adhesives and pavement striping compounds as well as petroleum wax modifiers for use in candles, investment casting, cable filling, and various paperboard coatings. Numerous types of Epolene polymers are available, and properties can be selected to fit various processing operations.

Further non-limitative examples of suitable compatibilizers include Polybond® 1001, Polybond® 1002, Polybond® 1009, Polybond® 3000, Polybond® 3002, Polybond® 3009, Polybond® 3150, and Polybond® 3200. The Polybond® series is commercially available from Chemtura, USA, and are polypropylenes and/or polyethylenes functionalized with maleic anhydride. Polybond® 3150 has a MFI of 50 g/10 min, 230° C., 2.16 kg; and Polybond® 3200 has a MFI of 110 g/10 min, 190° C., 2.16 kg.

Several other companies also produce polymer compatibilizers including E.I. du Pont de Nemours and Company (Wilmington, Del., USA), Dow Chemical Company (Midland, Mich., USA), ExxonMobil Corporation (Irving, Tex., USA) and Solvay S.A. (Brussels, Belgium).

Algae (singular alga) are from a large group of diverse organisms that vary from single cells to multiple cells and include marine organisms such as seaweed and diatoms. Most algae perform photosynthesis but not all. The biological definition for algae requires that the organisms be eukaryotes but for this invention, prokaryotes often called algae, such as cyanobacteria also known as blue green algae, is also considered algae.

Algae are used for many commercial purposes. Traditionally, algae have been used as food source. For food, algae may be used without modification such as in soups, dried as in ‘nori’ or wraps for sushi or extracted or denatured to provide karrageenan, proteins, nutrients and animal feed filler. Newer applications include industrial and sewage effluent treatment, stack gas remediation for carbon dioxide capture and extraction for biofuels.

Algae products include algae itself, dried algae or the algae biomass that is leftover from the processing of algae through extraction or other means.

Algae products typically have a strong odor. However, the odor of algae products can be reduced or eliminated through several means. The odor and color of algae products can be reduced or eliminated through bleaching by chemicals, including bleach and hydrogen peroxide, or light; the odor and color of the polymer with algae product can also be reduced through bleaching with chemicals or light. When bleached the algae color typically is reduced from a medium to dark green, brown or red to an off-white, tan, gray or very light green color.

The algae products can be dried to improve processability. The algae product (e.g., when dried) may include less than or equal to 5% moisture by weight and, in some cases, less than or equal to 4% moisture by weight.

The algae products can also be ground or powdered. The average particle size may be less than 50 microns and, in some cases, less than 20 microns.

In certain embodiments, the composition may include polymeric material from about 10% to about 95% by weight, compatibilizer from about 1-10% by weight and algae product from about 5% to about 90% by weight. In some embodiments, the polymeric material is from about 40% to about 95% by weight, the compatibilizer is from about 3-7% by weight and the algae product is from about 5% to about 60% by weight.

Mixing technology and unique reactive extrusion via twin screw processing can be used to form articles with the polymer compositions. Secondary processing such as thermoforming, injection molding, blow molding, film blowing, film extrusion, stretch blow molding (SBM), extrusion coating, profile extruding and extrusion blow molding (EBM) can also be used to produce various articles made from the polymer compositions.

In an embodiment, the polymer compositions can comprise suitable amounts of one or more additional components such as, for example, plasticizers, stabilizers, colorants, antioxidants, flavorants, nanofillers, non-clay particles, glass-fiber reinforcements, anti-microbial agents, processing aids or combination thereof.

Many polymers, such as polyolefins, are hydrophobic in nature. Algae products are typically hydrophilic. Physically blending hydrophobic polymers and algae product and processing the mixture in conventional melt processing units results in an incompatible blend having poor physical/mechanical properties and poor interfacial adhesion.

The starch can be made from any suitable source such as corn, tapioca, maize, wheat, rice, potato, sweet potato, pea or combination thereof. The starch can be in any suitable form such as, for example, a powder and may be chemically unmodified or modified. The starch may be present in the composition at from about 10% to about 40%.

The plasticizer can be, for example, any suitable material that softens and/or adds flexibility to the materials they are added to. The plasticizers can soften the final product increasing its flexibility. Suitable plasticizer include, for example, polyethylene glycol, sorbitol, glycerine or combination thereof.

Industrial plasticizers are discussed in the Encyclopedia of Chemical Technology, 4^{th} ed., Vol. 19, pp. 258-280, 1997. A plasticizer is a substance which, when added to another material, increases the softness and flexibility of that material. Without being bound by theory, it is believed that plasticizers increase flexibility of polymeric materials by increasing the free volume within the material. Randomly distributed within the material and interspersed among the polymer chains, the plasticizer molecules interfere with the polymer's ability to align its chains and pack into ordered structures. Molecular ordering increases the density of the material (decreases free volume) and impedes mobility of the polymer chains within the material. The increase in free volume imparted by the plasticizer allows room for chain segments to move. The material can then more readily accommodate an applied force by deforming. Particular examples of suitable plasticizers include glycerol, diethylene glycol, sorbitol, sorbitol esters, maltitol, sucrose, fructose, invert sugars, corn syrup, and mixtures of one or more of these.

Some non-limitative examples of suitable stabilizers include Irganox® Antioxidant 1010, B-225, B-900, and Irgastab® FS 301 and FS 210 FF, each commercially available from BASF SE, in Ludwigshafen, Germany. Some light stabilizers are commercially available from BASF under the tradenames CHIMASSORB®. Further available from BASF is Tinuvin® 770 DF, which is a light stabilizer belonging to the class of hindered amine light stabilizers, as well as Tinuvin 944, Tinuvin 123 and Tinuvin 328. A further example of a suitable stabilizer is Irganox 168.

If a color concentrate is desired, the mixture may further include one or more colorants, such as pigment(s) and/or dye(s). Organic or inorganic filler or pigment particles can be used. The pigments may be chosen from a list including clays, calcium carbonate, titanium dioxide and synthetic organic and inorganic pigments, as well as pigments produced from natural sources.

Nanofillers may comprise any suitable compound. In an embodiment, the nanofiller comprises an organoclay. Some non-limitative examples of suitable organoclay materials include Cloisite® Na+, Cloisite 30B, Cloisite 10A, Cloisite 25A, Cloisite 93A, Cloisite 15A, Cloisite 20A. The Cloisite clays are proprietary nanoclays commercially available from Southern Clay Products, a subsidiary of Rockwood Specialties, Inc., located in Princeton, N.J. Suitable organoclay may also be obtained from Nanocor.

The anti-microbial agents can be metal-based agents such as zinc oxide, copper and copper compounds, silver and silver compounds, colloidal silver, silver nitrate, silver sulphate, silver chloride, silver complexes, metal-containing zeolites, surface-modified metal-containing zeolites or combination thereof. The metal-containing zeolites can comprise a metal such as silver, copper, zinc, mercury, tin, lead, bismuth, cadmium, chromium, cobalt, nickel, zirconium and combinations thereof. In another embodiment, the anti-microbial agents can be organic-based agents such as o-benzyl-phenol, 2-benzyl-4-chloro-phenol, 2,4,4′-trichloro-2′-hydroxydiphenyl ether, 4,4′-dichloro-2-hydroxydiphenyl ether, 5-chloro-2-hydroxy-diphenyl-methane, mono-chloro-o-benzyl-phenol, 2,2′-methylenbis-(4-chloro-phenol), 2,4,6-trichlorophenol and combinations thereof.

In another embodiment, the present disclosure provides a method of making a polymer composition. The method comprises—processing a polymeric material, compatibilizer and algae product to form a compounded plastic. The compounded plastic can be produced by using known plastics compounding equipment and their associated processing methods but preferred equipment are those tailored for handling minerals and powders including Banbury mixers and Farrel continuous mixers with secondary downstream extrusion and single- or twin-screw extruders. Of the extruders, twin-screw extruders can be preferred in certain embodiments due to the better capability to tailor the amount of shear and mixing by equipment setup and processing conditions. In the single-screw and twin-screw extruders, the algae product can be fed into the main feed but downstream feeding is often best to better mix the algae product into the already molten polymeric material/compatilizer blend in the extruder. The single- and twin-screw extruders are typically of longer L:D ratio; in some cases, longer than 30:1 and, in some cases, longer than 34:1, to properly disperse and distribute the algae product.

At the end of the compounding process, the extrudate can then be made into pellets by any suitable means including by passing through a strand die, water bath and pelletizer or through an underwater pelletizer. The method can also comprise shaping the extrudate to form articles such as toys, computer casing, DVDs, toiletries, combs, consumer products, cellular phone casings, bags, foam material products, packaging, automobile parts, cookware or combination thereof.

The articles can be made by any suitable process such as, for example, injection molding, thermoforming, film blowing, film extrusion, stretch blow molding, extrusion blow molding, extrusion coatings, profile extrusion, cast films, cast products or combinations thereof.

In yet another embodiment, an article is produced using a composition comprising a polymer and an algae product. The article may be any that can be produced from plastic including from the group comprised of toys, computer casings, DVDs, toiletries, combs, consumer products, cellular phone casings, bags, foam material products, packaging, automobile parts, cookware and combinations thereof.

The article may be made by a process selected from the group comprised of injection molding, thermoforming, blown film extrusion, stretch blow molding, extrusion blow molding, extrusion coating, profile extrusion, cast film extrusion, sheet extrusion, thermoforming, and cast molding and combinations thereof.

By way of example and not limitation, the following examples are illustrative of various embodiments of the present invention.

### Example 1

| MATERIALS | % |
|---|---|
| Polypropylene | 72 |
| Maleic Anhydride Grafted | 5 |
| Polypropylene | |
| Thermoplastic Elastomer | 8 |
| Corn Starch | 7.5 |
| Unground Algae | 7.5 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product and corn starch were blended in a high speed mixer and fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 0.14% was measured on the pellets using a Sartorius MA 100 moisture analyzer. The melt flow index of 11.8 g/10′ at 190 C/2.16 kg/5 min hold was measured on pellets using a Custom Scientific CSI-127 melt flow index tester following the ASTM D1238 test procedure.

Pellets were also injection molded to produce 4″ discs and physical property testing specimens. Flexural modulus of 87 kpsi and flexural strength of 1790 psi were measured on a Zwick/Roell Z020 tensile/flex tester using a three-point flex testing jig following ASTM D790-10 test procedure. The tensile strength of 2490 psi and tensile elongation of 21% was measured using a Type 1 tensile bar on a Zwick/Roell Z020 tensile/flex tester following ASTM D638-10 test procedure. The Gardner impact of 123 in-lb was measured using a Gardner impact tester following ASTM D1709-09 test procedure. A rough surface appearance was noted also on the molded parts.

A very strong odor was noted on the pellets and molded parts.

### Example 2

| MATERIALS | % |
|---|---|
| Polypropylene | 72 |
| Maleic Anhydride Grafted | 5 |
| Polypropylene | |
| Thermoplastic Elastomer | 8 |
| Corn Starch | 7.5 |
| Unground Algae #2 | 7.5 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product and corn starch were blended in a high speed mixer and fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 0.32% was measured on the pellets using a Sartorius MA 100 moisture analyzer. The melt flow index of 10.6 g/10′ at 190 C/2.16 kg/5 min hold was measured on pellets using a Custom Scientific CSI-127 melt flow index tester following the ASTM D1238 test procedure.

Pellets were also injection molded to produce 4″ discs and physical property testing specimens. Flexural modulus of 92 kpsi and flexural strength of 3000 psi were measured on a Zwick/Roell Z020 tensile/flex tester using a three-point flex testing jig following ASTM D790-10 test procedure. The tensile strength of 2530 psi and tensile elongation of 16% was measured using a Type 1 tensile bar on a Zwick/Roell Z020 tensile/flex tester following ASTM D638-10 test procedure. The Gardner impact of 129 in-lb was measured using a Gardner impact tester following ASTM D1709-09 test procedure. A very rough surface appearance was noted also on the molded parts.

A very strong odor was noted on the pellets and molded parts.

### Example 3

| MATERIALS | % |
|---|---|
| Polypropylene | 67 |
| Maleic Anhydride Grafted | 5 |
| Polypropylene | |
| Thermoplastic Elastomer | 8 |
| Corn Starch | 10 |
| Ground Algae | 10 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product and corn starch were blended in a high speed mixer and fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 0.12% was measured on the pellets using a Sartorius MA 100 moisture analyzer. The melt flow index of 10.6 g/10′ at 190 C/2.16 kg/5 min hold was measured on pellets using a Custom Scientific CSI-127 melt flow index tester following the ASTM D1238 test procedure.

Pellets were also injection molded to produce 4″ discs and physical property testing specimens. Flexural modulus of 94 kpsi and flexural strength of 3190 psi were measured on a Zwick/Roell Z020 tensile/flex tester using a three-point flex testing jig following ASTM D790-10 test procedure. The tensile strength of 2630 psi and tensile elongation of 14% was measured using a Type 1 tensile bar on a Zwick/Roell Z020 tensile/flex tester following ASTM D638-10 test procedure. The Gardner impact of 76 in-lb was measured using a Gardner impact tester following ASTM D1709-09 test procedure. A matte surface appearance was noted also on the molded parts.

A strong odor is noted on the pellets and molded parts.

### Example 4

| MATERIALS | % |
|---|---|
| Polypropylene | 67 |
| Maleic Anhydride Grafted | 5 |
| Polypropylene | |
| Thermoplastic Elastomer | 8 |
| Corn Starch | 10 |
| Unground Algae | 10 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product and corn starch were blended in a high speed mixer and fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 0.16% was measured on the pellets using a Sartorius MA 100 moisture analyzer. The melt flow index of 10.2 g/10′ at 190 C/2.16 kg/5 min hold was measured on pellets using a Custom Scientific CSI-127 melt flow index tester following the ASTM D1238 test procedure.

Pellets were also injection molded to produce 4″ discs and physical property testing specimens. Flexural modulus of 81 kpsi and flexural strength of 2690 psi were measured on a Zwick/Roell Z020 tensile/flex tester using a three-point flex testing jig following ASTM D790-10 test procedure. The tensile strength of 2450 psi and tensile elongation of 17% was measured using a Type 1 tensile bar on a Zwick/Roell Z020 tensile/flex tester following ASTM D638-10 test procedure. The Gardner impact of 113 in-lb was measured using a Gardner impact tester following ASTM D1709-09 test procedure. A rough surface appearance was noted also on the molded parts.

A strong odor was noted on the pellets and molded parts.

### Example 5

| MATERIALS | % |
|---|---|
| Polypropylene #2 | 60 |
| Maleic Anhydride Grafted | 5 |
| Polypropylene | |
| Thermoplastic Elastomer | 5 |
| Dried, Powdered Algae Biomass | 30 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product was fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 0.33% was measured on the pellets using a Sartorius MA 100 moisture analyzer. The melt flow index of 25.7 g/10′ at 190 C/2.16 kg/5 min hold was measured on pellets using a Custom Scientific CSI-127 melt flow index tester following the ASTM D1238 test procedure. The 1.01 g/cc density was measured on a Carver press pressout using a Mettler Toledo ML54 electronic balance with densimeter option using ethanol as the liquid medium following ASTM D792-08 test procedure.

Pellets were also injection molded to produce 4″ discs and physical property testing specimens. Flexural modulus of 182 kpsi and flexural strength of 5340 psi were measured on a Zwick/Roell Z020 tensile/flex tester using a three-point flex testing jig following ASTM D790-10 test procedure. The tensile strength of 3410 psi and tensile elongation of 4% was measured using a Type 1 tensile bar on a Zwick/Roell Z020 tensile/flex tester following ASTM D638-10 test procedure. The Gardner impact of 18 in-lb was measured using a Gardner impact tester following ASTM D1709-09 test procedure. A rough surface appearance was noted also on the molded parts.

A strong odor was noted on the pellets and molded parts.

### Example 6

| MATERIALS | % |
|---|---|
| Thermoplastic Polyolefin | 45 |
| Maleic Anhydride Grafted | 5 |
| Polypropylene | |
| Thermoplastic Elastomer | 5 |
| Dried, Powdered Algae Biomass | 45 |

### Processing Steps:

A blend of thermoplastic polyolefin, maleic anhydride grafted polypropylene and thermoplastic elastomer was prepared in a low shear mixer and fed to the main feeder of the twin screw extruder using a volumetric screw feeder. The algae product was fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 1.0% was measured on the pellets using a Sartorius MA 100 moisture analyzer. The melt flow index of 2.5 g/10′ at 190 C/2.16 kg/5 min hold was measured on pellets using a Custom Scientific CSI-127 melt flow index tester following the ASTM D1238 test procedure. The 1.10 g/cc density was measured on a Carver press pressout using a Mettler Toledo ML54 electronic balance with densimeter option using ethanol as the liquid medium following ASTM D792-08 test procedure.

Pellets were also injection molded to produce 4″ discs and physical property testing specimens. Flexural modulus of 18.5 kpsi and flexural strength of 710 psi were measured on a Zwick/Roell Z020 tensile/flex tester using a three-point flex testing jig following ASTM D790-10 test procedure. The tensile strength of 833 psi and tensile elongation of 120% was measured using a Type 1 tensile bar on a Zwick/Roell Z020 tensile/flex tester following ASTM D638-10 test procedure. The Gardner impact of 18 in-lb was measured using a Gardner impact tester following ASTM D1709-09 test procedure. A matte surface appearance was noted also on the molded parts.

A strong odor was noted on the pellets and molded parts.

### Example 7

| MATERIALS | % |
|---|---|
| Polypropylene | 60 |
| Maleic Anhydride Grafted | 5 |
| Polypropylene | |
| Thermoplastic Elastomer | 5 |
| Corn Starch | 15 |
| Dried Powdered Algae Biomass | 15 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product and corn starch were blended in a high speed mixer and fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

Moisture content of 0.16% was measured on the pellets using a Sartorius MA 100 moisture analyzer. The melt flow index of 8.3 g/10′ at 190 C/2.16 kg/5 min hold was measured on pellets using a Custom Scientific CSI-127 melt flow index tester following the ASTM D1238 test procedure. The 1.00 g/cc density was measured on a Carver press pressout using a Mettler Toledo ML54 electronic balance with densimeter option using ethanol as the liquid medium following ASTM D792-08 test procedure.

Pellets were also injection molded to produce 4″ discs and physical property testing specimens. Flexural modulus of 130 kpsi and flexural strength of 3740 psi were measured on a Zwick/Roell Z020 tensile/flex tester using a three-point flex testing jig following ASTM D790-10 test procedure. The tensile strength of 3070 psi and tensile elongation of 8% was measured using a Type 1 tensile bar on a Zwick/Roell Z020 tensile/flex tester following ASTM D638-10 test procedure. The Gardner impact of 27 in-lb was measured using a Gardner impact tester following ASTM D1709-09 test procedure. A matte surface appearance was noted also on the molded parts.

A strong odor was noted on the pellets and molded parts.

### Example 8

| MATERIALS | % |
|---|---|
| Polypropylene #3 | 67 |
| Maleic Anhydride Grafted | 5 |
| Polypropylene | |
| Thermoplastic Elastomer | 5 |
| Ground Algae #3 | 20 |

### Processing Steps:

A blend of polypropylene, maleic anhydride grafted polypropylene and thermoplastic elastomer was prepared in a low shear mixer and fed to the main feeder of the twin screw extruder using a volumetric screw feeder. The algae product was fed into the twin screw extruder through a side feeder using another volumetric screw feeder. The extruder screw and barrel configuration was optimized to handle the large vapor quantity through back venting upstream of the side feeder.

The twin-screw extruder was a 36:1 Length:Diameter (L:D) co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized. Moisture content of 0.20% was measured on the pellets using a Sartorius MA 100 moisture analyzer. The melt flow index of 24.0 g/10′ at 190 C/2.16 kg/5 min hold was measured on pellets using a Custom Scientific CSI-127 melt flow index tester following the ASTM D1238 test procedure. The 0.94 g/cc density was measured on a Carver press pressout using a Mettler Toledo ML54 electronic balance with densimeter option using ethanol as the liquid medium following ASTM D792-08 test procedure.

Pellets were also injection molded to produce 4″ discs and physical property testing specimens. Flexural modulus of 130 kpsi and flexural strength of 3740 psi were measured on a Zwick/Roell Z020 tensile/flex tester using a three-point flex testing jig following ASTM D790-10 test procedure. The tensile strength of 3070 psi and tensile elongation of 3% was measured using a Type 1 tensile bar on a Zwick/Roell Z020 tensile/flex tester following ASTM D638-10 test procedure. The Gardner impact of 20 in-lb was measured using a Gardner impact tester following ASTM D1709-09 test procedure. The semi-glossy surface appearance was noted also on the molded parts.

The minimal odor was noted on the pellets and molded parts.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A composition comprising:
a polymeric material;
a compatibilizer; and
an algae product.

2. The composition of claim 1, wherein the polymeric material is selected from the group comprised of polyolefins, polyamides, polyesters and polyacrylates.

3. The composition of claim 2, wherein the polyolefin is selected from the group consisting of polyethylene, polypropylene, polybutene and other combinations of olefinic monomers selected from the group consisting of ethylene, propylene, butene, butadiene, pentene, hexene, octane, styrene, acrylates and methacrylates.

4. The composition of claim 2, wherein the polyester is selected from the group consisting of polylactic acid, polybutylene succinate, polybutylene adipate-co-terephthalate, polyethylene terephthalate, polyhydroxy alkanoate and combinations thereof.

5. The composition of claim 2, wherein the polyamide is selected from the group consisting ofpolyamide 6, polyamide 10, polyamide 4, 10, polyamide 66, polyamide 12 and combinations thereof.

6. The composition of claim 1, wherein the compatibilizer is selected from the group consisting of grafted or functionalized polymers including maleic anhydride grafted polypropylene, glycidyl grafted polypropylene, maleic anhydride grafted polyethylene, maleic anhydride grafted polybutene and combinations thereof.

7. The composition of claim 1, wherein the compatibilizer comprises maleated polypropylene with a melt flow of about 50 to about 500 g/10 minute and maleic anhydride grafting of about 0.5 to about 10 wt %.

8. The composition of claim 1, wherein the algae product is algae itself or algae biomass.

9. The composition of claim 8, wherein the algae biomass is the result of extraction or removal of biofuel, nutrients, pharmaceuticals and other specialty chemicals.

10. The composition of claim 8, wherein the algae product has less than or equal to 5% moisture by weight.

11. The composition of claim 8, wherein the algae product has an average particle size less than or equal to 50 microns.

12. The composition of claim 1, wherein the algae product has substantially no odor.

13. The composition of claim 1, wherein the algae product is bleached by chemicals or light prior to use.

14. The composition of claim 13, wherein the composition is bleached by chemicals or light.

15. The composition of claim 1, wherein the polymeric material comprises from about 10% to about 94% by weight, the compatibilizer comprises from about 1 to about 10% by weight and the algae product comprises from about 5% to about 90%.

16. The composition of claim 1, wherein the polymeric material comprises from about 35% to about 92% by weight, the compatibilizer comprises from about 3 to about 7% by weight and the algae product comprises from about 10% to about 60%.

17. The composition of claim 1 further comprising at least one component selected from the group consisting of plasticizers, starches, stabilizers, colorants, antioxidants, flavorants, nanofillers, non-clay particles, glass-fiber reinforcements, anti-microbial agents, processing aids and combinations thereof.

18. The composition of claim 17, wherein the starch is selected from the group consisting of corn, tapioca, maize, wheat, rice, potato, sweet potato and pea and combinations thereof.

19-24. (canceled)

25. A method of making a polymer composition, the method comprising:
blending a polymeric material, a compatibilizer, and an algae product to form a finished plastic pellet using extrusion.

26-27. (canceled)

28. An article comprising the composition of claim 1.

29-30. (canceled)
